(19) United States
(12) Patent Application Publication
(10) Pub. No.: US 2024/0104318 A1
(43) Pub. Date: Mar. 28, 2024

(54) SYSTEMS AND METHODS FOR TRACKING ASSETS USING A MOVING DEVICE

(71) Applicant: Brunswick Corporation, Mettawa, IL (US)

(72) Inventor: Sean Minogue, Satellite Beach, FL (US)

(73) Assignee: Brunswick Corporation, Mettawa, IL (US)

(21) Appl. No.: 17/392,743

(22) Filed: Aug. 3, 2021

(51) Int. Cl. G06K 7/10

(52) U.S. Cl. CPC G06K 7/10475

(57) ABSTRACT

A system for tracking assets having tags using a moving device. The system includes a tag reader having a range and being located on the moving device. The tag reader is configured to read asset data from each of the tags within the range of the tag reader. A location tracker detects a geographic location of the moving device and asset locations are determined for the assets based on the geographic location detected. A wireless transmitter is located on the moving device. The wireless transmitter communicates the asset data and the asset locations for each of the tags read by the tag reader. A computing system receives the asset data and the asset locations and maintains a database of the asset data and the asset locations for the assets.

### FIELD

The present disclosure generally relates to systems and methods for tracking assets using a moving device, such as a fork lift.

### BACKGROUND

RFID tags are devices known in the art for tagging objects, which can be digitally read by an RFID reader to determine the identity of, and/or other information relating to, the object.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One embodiment of the present disclosure generally relates to a system for tracking assets having tags using a moving device. The system includes a tag reader having a range and being located on the moving device. The tag reader is configured to read asset data from each of the tags within the range of the tag reader. A location tracker detects a geographic location of the moving device and asset locations are determined for the assets based on the geographic location detected. A wireless transmitter is located on the moving device. The wireless transmitter communicates the asset data and the asset locations for each of the tags read by the tag reader. A computing system receives the asset data and the asset locations and maintains a database of the asset data and the asset locations for the assets.

Another embodiment generally relates to a method for tracking assets having tags using a moving device. The method includes reading with a tag reader having a range asset data from each of the tags within the range, where the tag reader is located on the moving device. The method further includes detecting with a location tracker a geographic location of the moving device, where the location tracker is located on the moving device. The method further includes determining asset locations for the assets based on the geographic location. The method further includes communicating via a wireless transmitter the asset data and the asset locations for each of the tags read, where the wireless transmitter is located on the moving device. The method further includes receiving by a computing system the asset data and the asset locations and maintaining a database of the asset data and the asset locations for the assets.

Another embodiment generally relates to a system for tracking assets with RFID tags using a moving device. Four RFID tag readers each having a range are divided by a shield into four quadrants, where each of the four RFID tag readers is located within a separate one of the four quadrants and is configured to read asset data from each of the RFID tags within the range thereof. A location tracker is located on the moving device, where the location tracker detects a geographic location of the moving device in three dimensions in real-time. The asset locations are determined for the assets based on the geographic location of the moving device when each of the RFID tags was read. A wireless transmitter is located on the moving device, which communicates via Wi-Fi or mesh network the asset data and the asset locations for each of the tags read. A computing system receives the asset data and the asset locations and maintains a database thereof for the assets. A memory system located on the moving device stores the asset data and the asset locations until received by the computing system.

Various other features, objects and advantages of the disclosure will be made apparent from the following description taken together with the drawings.

### BRIEF DESCRIPTION OF THE DRAWINGS

The present disclosure is described with reference to the following drawings.

FIG. 1 is an overhead view of a system for tracking assets using a moving device according to the present disclosure;

FIG. 2 is an overhead closeup of a moving device configured for tracking assets according to the present disclosure;

FIG. 3 is a schematic of an exemplary control system within a system according to the present disclosure;

FIG. 4 is a process flow chart for a method of tracking assets according to the present disclosure;

FIG. 5 is a visual representation of a system using a fork lift as the moving device according to the present disclosure; and

FIG. 6 is a visual representation of a system using a rolling cart as the moving device according to the present disclosure for tracking assets.

### DETAILED DISCLOSURE

The present inventor has recognized that methods presently known in the art for tracking the locations of assets are time-consuming and prone to inaccuracy. The problem is further exacerbated when the assets to be tracked are stored, transportation, and used over a physically large area. In some industries, assets are located in multiple, separate areas spread across many acres. For example, production facilities that manufacture a wide variety of goods, large goods, and/or goods requiring large equipment or tooling may be spread across a very large area. Fiberglass boat manufacturers are one such example, whereby thousands of molds, dollies, and other assets may be stored and used over many years for producing a wide variety of hulls, parts, and accessories.

As the size of the manufacturer's property increases, so does the challenge in efficiently detecting the locations of a given asset within that property. Similarly, problems arise with maintaining the accuracy of a database storing the identities and locations of each of the many assets over time. The number, size, and variety of individual areas within the property (e.g., separate buildings) also creates problems with respect to communicating information relating to assets back to the database. For example, the property may extend across a great distance, include both indoor and outdoor areas, and contain many obstacles and/or sources of interference with respect to electronic communication. Additionally, assets that require tracking may be visually obscured, rendering traditional methods of manually taking inventory impossible. For example, an asset stored outside may be covered in snow.

RFID tags are one tool for labeling and wirelessly detecting assets, whereby the each RFID tag is known to be associated with a particular asset and digitally contains relevant information corresponding thereto. However, the present inventor has recognized that the distance (or range) for an RFID reader to read an RFID tag is typically no more than 20-25 feet, as RFID readers are customarily limited to a signal power of only one watt of power (as currently limited by FCC code, e.g. 47 CFR § 15.247). In this manner, RFID readers can be used to detect the location of an asset via its RFID tag, assuming the RFID tag is within range, relative to the RFID reader. Since it is the absolute (not relative) location of the asset that is to be tracked, the location of the RFID reader must then also be known to make detection of the RFID tags useful.

Unlike RFID readers and other short-range wireless communication protocols, GPS provides a mechanism for determining the absolute, geographic location of an asset. However, the present inventor has recognized that GPS provides relatively coarse accuracy (e.g., within 16 feet). Additionally, GPS typically does not operate indoors, and thus is a generally poor solution for sizable properties having both indoor and outdoor spaces. Another problem solved by the presently disclosed system 30 is the unification of indoor and outdoor solutions into a single form that works within a common firewall. In particular, outdoor RFID solutions typically use cellular and GPS, whereas internal RFID solutions rely on wi-fi and other location methods. This requires two separate RFID systems (one outside and one inside), which creates complexity and security vulnerability with respect to a network firewall. Furthermore, no outdoor systems presently integrate within the firewall of indoor systems. By employing the presently disclosed system 30, which itself communicates between indoor and outdoor spaces, the entire solution is unified and can be inside an existing firewall of a facility.

If the absolute location of an asset can be successfully determined, the location of the asset and/or reader (e.g., an RFID reader) must be communicated to the database, preferably wirelessly and in real-time or near real-time. Wi-Fi has become a well-established mechanism for wirelessly communicating information, the size and mixture of indoor and outdoor facilities can easily exceed the range capabilities of Wi-Fi and other mainstream wireless communication protocols (e.g., Bluetooth®, Zigbee, etc.).

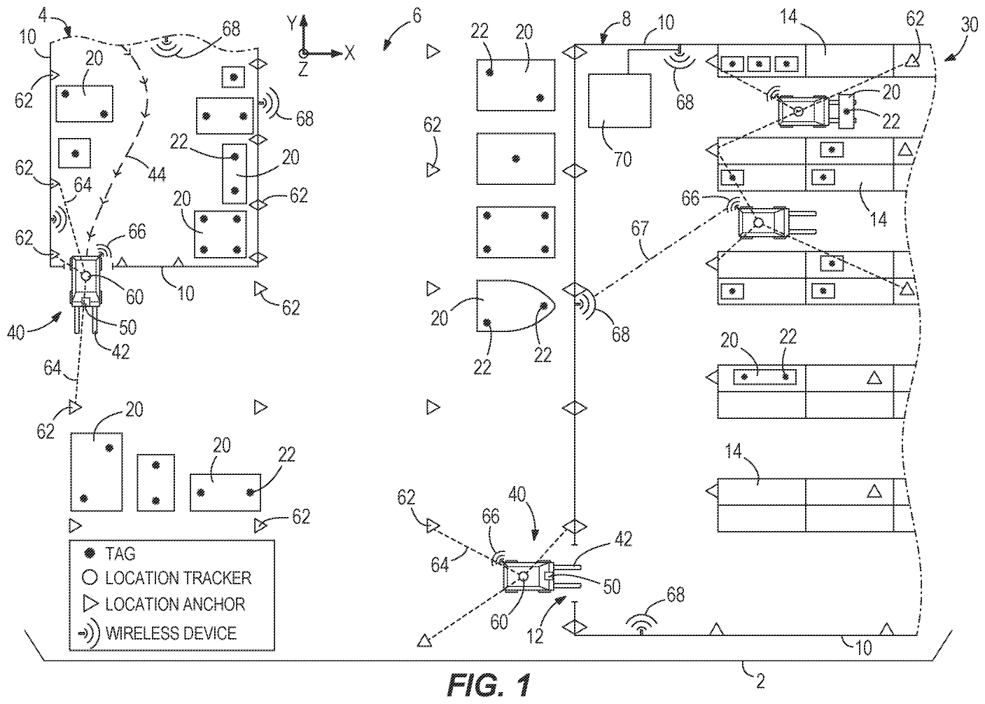

Through experimentation and development, the present inventor has created systems and methods for addressing the unique problems of tracking assets over large spaces, including both indoor and outdoor areas of concern, and also handling communication of this information. FIG. 1 is an overhead view of a system 30 according to the present disclosure for tracking assets using a moving device. The property 2 is divided into a first area 4, a second area 6, and a third area 8. The first area 4 and the third area 8 are indoors, for example warehouses for storing and/or using assets 20 for various manufacturing processes. These assets 20 may be equipment for the manufacturing process (e.g., fiberglass molds, presses, robotic devices, calibration devices), raw materials (e.g., containers of adhesive, spools of wire or glass for fiberglass, parts), and/or works in process or completed goods, for example. The remaining portion of the property 2 is designated as the second area 6 and shown to be outside, for example an open lot or field between the buildings shown as the first area 4 and third area 8. The property 2 may span across great distances and having varying topography. As will become apparent, the system 30 provides for detecting and tracking the geographic location XYZ of each of the assets 20 within the property 2, and in all three dimensions.

The third area 8 of FIG. 1 is defined by walls 10 having a door 12 through which a moving device 40, shown here as a forklift, may enter and exit. Other exemplary moving devices 40 include manually-rolled carts, pallet jacks, golf carts, and robotic movers, or any other device configured to move about (including those not configured to carry assets 20, for example a people-mover such as the Ninebot by Segway®). The various assets 20 each have one or more tags 22 associated therewith and are stored within the property 2. Some assets 20 are stored on the ground, such as a large mold for the fiberglass hull of a yacht, or stored on shelves 14 such as shown within the third area 8. The tags 22 are used for labeling the identity of the assets 20 (e.g., a name and/or serial number), but may also contain other information relating thereto, such as additional content or ingredient information, batch numbers, expiration dates, and/or the like (collectively referred to as asset data). The moving device 40 travels along a path of travel 44 carrying assets 20 throughout the property 2, for example using forks 42 in a manner presently known in the art.

With continued reference to FIG. 1, each moving device 40 is equipped with a tag reader 50 configured to read the tags 22 associated with the assets 20. This includes not only the tags 22 associated with an asset 20 that the moving device 40 is transporting, but any tags 22 within range of the tag reader 50 as the moving device 40 travels about. In certain embodiments in which a forklift is the moving device 40, the tag reader 50 may be positioned to move in the Z-direction (elevation) along with the forks 42. This allows the elevation of the tags 22 to also be determined, specifically by comparing tag readings to the known height of the forks 42 at any given time. Positioning the tag reader 50 to move with the forks 42 enables the reading of additional tags 22 for assets 20 that are too far to otherwise be read from the ground. For example, assets 20 on a top rack of a tall storage unit can then be detected (e.g., those greater than 25′ away from the base of the moving device 40).

Each moving device 40 also includes a location tracker 60 for determining the X, Y, and Z coordinates (collectively referred to as the geographical location XYZ) of the center of the moving device 40 as it moves within the property 2. Specifically, the location tracker 60 is used to determine a geographic location XYZ of the location tracker 60, which is used to infer the geographic location XYZ of the moving device 40 by knowing the location of the location tracker 60 relative to the center of the moving device 40. The geographic location XYZ of the moving device 40 is then be used to determine the geographic location XYZ of an asset 20 (also referred to as the asset location) when that asset's tag 22 is read by the tag reader 50. Additional information regarding the location tracker 60 is provided below, as well as how the X, Y, and Z coordinates of the asset 20 are determined based on the geographic location XYZ of the moving device 40 when the tag 22 is read.

The geographic location XYZ of the moving device 40 and the assets 20 may be provided as absolute X, Y, and Z coordinates (e.g., when using global positioning satellites as the location tracker 60), or relative X, Y, and Z coordinates (e.g., when the location tracker 60 uses triangulation between the moving device 40 and fixed anchors, for example when using Decawave®). Additionally, relative X, Y, Z, coordinates for the moving device 40 and assets 20 may be made absolute by knowing the absolute X, Y, Z coordinates of the fixed anchors that are used for relatively locating the moving device 40 and assets 20.

Also shown in FIG. 1, the moving device 40 is provided with a wireless transmitter 66, which is configured for communicating with a remote computer 70 and/or other moving devices 40. The wireless transmitter 66 includes the hardware and software necessary to communicate via Wi-Fi, Xbee, Zigbee, Bluetooth®, or other protocols and standards known in the art for wireless communication. While referred to as a transmitter, it should be recognized that the wireless transmitter may alternatively be a transceiver for both transmitting and receiving data. As will be discussed further below, this allows moving devices 40 to not only communicate data relative to the assets 20, but also to communicate with and through each other.

The wireless transmitter 66 communicates the asset data and asset location of each of the assets 20 detected by the tag reader 50 and determined via the geographic location XYZ from the location tracker 60. The asset data and asset location sent along a wireless communication path 67 from the wireless transmitter 66 to a wireless receiver 68 of a remote computer 70, or another moving device 40. The remote computer 70 maintains a database of the asset data and asset locations for all of the assets 20 contained within the property 2.

In certain embodiments, elements requiring power may be powered by solar panels (particularly for outdoor, and especially distant locations), or by integration into existing equipment. For example, solar panels may be used to power XBee modules (or other elements as the wireless receivers 68), as well as Decawave tags (or other elements as location anchors 62, where applicable). The present inventors have further recognized that existing equipment may be configured to serve as location anchors 62 if they remain stationary. For example, a fixed workstation (e.g., a computer, conveyor system, or other electrical equipment) may integrate a Decawave tag therein such that no additional power source is needed. By integrating location anchors 62 into existing equipment and new equipment going forward, the range and accuracy of the overall system 30 only increases over time, and with modest additional cost.

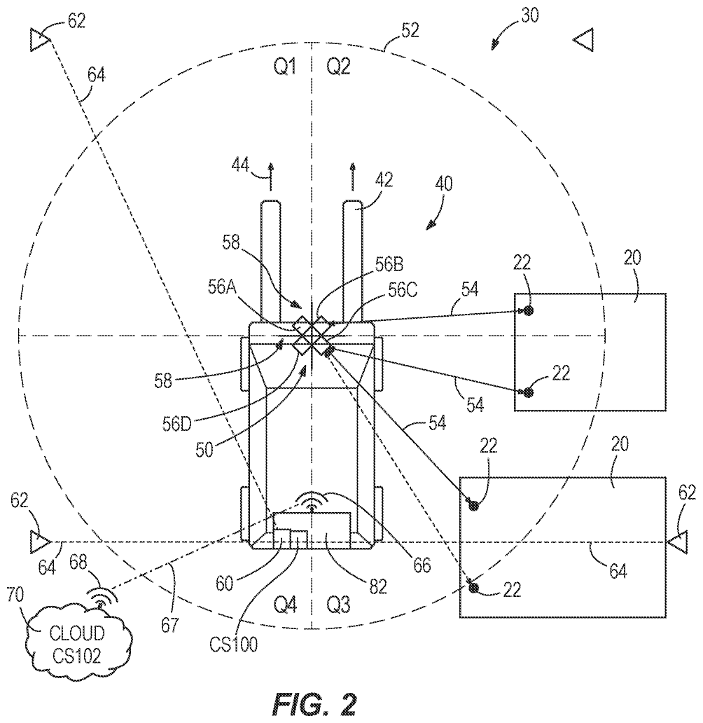

FIG. 2 is an overhead view of a moving device 40 configured according to the present disclosure, which in this case is a forklift like that shown in FIG. 1. The moving device 40 has a tag reader 50 configured to read the tags 22 of assets 20 within a range 52 of the tag reader 50. The tags 22 may be passive RAIN RFID tags containing an electronic product code (EPC) to be read in a manner known in the art. An exemplary tag reader 50 is the Impinj module RS2000 manufactured by Foxconn. Active tags used as the tags 22 may store additional information beyond the EPC, such as a location history of the tag 22, accounting information including value or whether to inventory an item associated with the tag 22, instructions for handling the item associated with the tag 22, and/or other items to provide with the item associated with the tag 22, for example.

In the case of passive RFID tags as the tags 22 and an RFID reader as the tag reader 50, the range 52 of the tag reader 50 may be a circle having a radius corresponding to the maximum reading distance of its tag read path 54. As previously discussed, this range 52 for RFID is approximately 20-25 feet, corresponding to the standard reading distance of RFID technology presently available in the art. However, it should be recognized that other technologies for tags 22 and tag readers 50 are also contemplated for the disclosed system 30 and may correspond to different ranges 52. These include active RFID tags as the tags 22, which may provide a greater range 52 for reading by the tag reader 50.

In this manner, asset data is read from any tag 22 within range 52 of the tag reader 50. The present inventor has also recognized that it can be advantageous for a single asset 20 to have multiple tags 22 associated therewith, particularly for physically large assets 20. For example, in the case of a 30 foot long boat hull, a tag 22 at one end would not be readable (at least via certain, passive RFID technology) by a tag reader 50 positioned at an opposite end of the asset 20. Even for assets 20 less than 20-25 feet long, it is possible that only one portion of that asset 20 will be within the range 52 of the moving device 40 moving along its path of travel 44, and thus more assets 20 can be detected by providing multiple tags 22 with the assets 20. While the multiple tags 22 for a single asset 20 can contain identical information, having tags 22 having different information (though all having a known association with the same asset 20) allows for determining additional information relating to the positioning of the asset 20. For example, having multiple tags 22 allows for labeling the front versus the back of a large asset 20, or a preferred end for lifting.

For the moving device 40 of FIG. 2, the tag reader 50 comprises four individual tag sensors 56A-56D. The individual tag sensors 56A-56D are not merely redundant, but are separated by a shield 58 to provide more refined directionality of the tags 22 being read. Specifically, the shield 58 is configured to block the individual tag sensors 56A-56D from reading tags 22 therethrough. For example, the shield may be made or a wire mesh or lead-based material designed to block wireless transmission. In certain examples, the shield is integrated directly into the individual tag sensors 56A-56D, for example in the case of “directional” RFID readers known in the art (e.g., a 90 degree tag reader 50 configured to read only within a 90 degree range). The shield 58 shown in FIG. 2 is configured to form two perpendicular lines dividing the moving device 40 into quadrants Q1-Q4. Due to the blocking of the shield 58, each of the individual tag sensors 56A-56D reads tags 22 only within a corresponding one of quadrants Q1-Q4 in which the individual tag sensor is located (also limited by the range 52 of the tag reader 50). Therefore, the individual tag sensors 56A-56D not only detect that a tag 22 has been found, but also detect a specific quadrant location for that tag 22 and thus an approximate direction of the tag with respect to the vehicle.

With reference to the example of FIG. 2, detection of a tag 22 by the second tag sensor 56B indicates that the asset 20 (and particularly a tag 22 associated therewith) is located within quadrant Q2 specifically, rather than within the entirety of the range 52 more generally. In the configuration shown in FIG. 2, the uppermost asset 20 has two tags 22, whereby the uppermost of the tags 22 is shown being read by the second tag sensor 56B, and the lowermost tag 22 being read by the third tag sensor 56C. Since these tags 22 each contain asset data corresponding to the same asset 20, this reading pattern indicates that the asset 20 must span across the second quadrant Q2 and third quadrant Q3 relative to the moving device 40 at that time.

It should be recognized that the present disclosure contemplates any number of tag readers 50 being located on the moving device 40. By way of non-limiting example, this includes two tag readers dividing the moving device 40 into semi-circular portions defined as being in front of and behind the center of the moving device 40, five tag readers 50 with four evenly divided in front of the moving device 40 with one behind, or 16 tag readers 50 evenly dividing the area surrounding the moving device 40 into 16 “slices”. In general, additional tag readers 50 allow for further refinement of the asset locations of assets 20 (particularly when a shield 68 is employed), and/or provide for redundancy. For example, tag readers 50 may be positioned to read within in a same vicinity as each other, but be positioned such that the signal strength of tags 22 varies between the tag readers 50 (offering further specificity of where the tag 22 is located within the vicinity).

In addition to using the quadrant-based system for identifying the asset locations of the asset 20 relative to the moving device 40 at the time of reading the tag 22, the tag reader 50 is also configured to determine a signal strength of each of the tags 22 being read. This further allows the system 30 to deduce a distance for the tag read path 54 between the tag reader 50 and the tag 22. This additional distance information allows for further refining the location of the tag 22 relative to the moving device 40 within one quadrant covering the entire possible range 52. Specifically, by knowing the determined signal strength, the possible locations of the tag 22 relative to the moving device 40 can be limited to an arc of possibilities within the quadrant associated with the corresponding one of the tag readers 50.

The location of the tag 22 may be even further refined by reading the tag 22 multiple times, either continuously or on a periodic basis. For example, if the moving device 40 of FIG. 2 continues driving upwardly along the path of travel 44 shown, the uppermost tag 22 will at some point leave the second quadrant Q2 and enter the third quadrant Q3. This indicates that the tag 22 is specifically at the intersection between the second quadrant Q2 and third quadrant Q3, thus narrowed to a single line defined based on the geographic location XYZ of the moving device 40 at that moment and the orientation of the quadrants with respect to the moving device 40. When paired with signal strength information, the asset location of the tag 22 can be further pinpointed to a specific position along this intersection. In this manner, the presently disclosed system 30 provides for detecting with high accuracy and precision the locations of the tags 22 relative to the moving device 40.

With continued reference to FIG. 2, the moving device 40 further includes a location tracker 60 that is configured to determine (in real-time) the geographic location XYZ of the moving device 40 within the property 2. If the geographic location XYZ of the moving device 40 is known, the system 30 can then deduce the geographic location XYZ of the tags 22 read by the tag readers 50 on that moving device 40 at the time the tags 22 are read. In other words, if the system 30 can determine the location of the tag 22 relative to the moving device 40 in the manner described above, the absolute location of the tag 22 can be determined by identifying the geographic location XYZ of the moving device 40 at that time. In the example shown in FIG. 2 in which a tag 22 has just moved from the second quadrant Q2 to the third quadrant Q3 and has a signal strength corresponding to 10 feet, the tag 22 is estimated to be 10 feet to the right of the moving device 40.

The location tracker 60 of FIG. 2 functions by communicating with location anchors 62 placed throughout the property 2. Here, the location tracker 60 and location anchors 62 use Decawave™ technology, which for example is commercially used for accurately and precisely identifying the geographic locations XYZ of players in a baseball game, and in real-time. In particular, the geographical location XYZ of the location tracker 60 is determined by triangulating the distances of location read paths 64 between the location tracker 60 and three or more location anchors 62, which provides an accuracy of ±1 cm. In this manner, the location tracker 60 is used to maintain a real-time geographic location XYZ of the moving device 40 as it travels throughout the property 2, therefore providing a basis for identifying the geographic locations XYZ of each of the tags 22 that the moving device 40 detects along the way.

With continued reference to FIG. 2, the moving device 40 is further equipped with a wireless transmitter 66 that communicates with wireless receivers 68 along a wireless communication path 67 therebetween. The wireless transmitter 66 may be Wi-Fi based technology that communicates with Wi-Fi receivers as the wireless receiver 68. Many wireless receivers 68 may be positioned throughout the property 2 to ensure broad coverage, as well as to avoid obstacles, to include indoor and outdoor areas, and the like.

The moving device 40 of FIG. 2 further includes a local computer 82 that includes a computing system CS100 discussed further below. In certain examples, a microprocessor (such as an STM32 by ST Electronics) transmits information from the location tracker 60 and/or tag reader 50 (e.g., communicating over UART) to an edge computing device (e.g., an Odroid H2+), which may be located on the moving device 40. The processing and communication described throughout this disclosure may be combined or divided while performing the same function, for example among all devices about the moving device 40. Therefore, for the sake of simplicity, the local computer 82 will be described as including all processing and communication aboard the moving device 40 unless otherwise stated or required. The local computer 82 enables a moving device 40 to store the asset data and asset location detected from tags 22 associated with the assets 20 until the asset data and asset location information can be transmitted to the remote computer 70 for updating the database. The asset data and asset location information may be communicated via the wireless transmitter 66 of the moving device 40 directly to a wireless receiver 68 connected to the remote computer 70, or indirectly through another moving device 40, depending on which is within range of the wireless transmitter 66. In this manner, a moving device 40 may travel where there is no wireless communication (outside of a building), collecting information from the tags 22 of every asset 20 within the range 52 of its tag reader 50 along the way and storing the information on its local computer 82. Once the moving device 40 comes within range of a wireless receiver 68 of the building, for example, all of the previously stored information corresponding to the asset data and asset locations of the assets 20 may be transmitted via the wireless transmitter 66 to the remote computer 70 for updating the database.

As previously discussed, the moving devices 40 are also configured to communicate with each other. For example, a wireless transmitter 66 of a first moving device 40 that is not within range of a wireless receiver 68 connected to the remote computer 70 may transmit the information to the computer via another moving device 40 that is within range of such a wireless receiver 68. In other words, moving devices 40 may serve as relay points for others. This extends the distance for which communication is effectively available over long distances, also potentially overcoming various sources of interference present (e.g., going around corners).

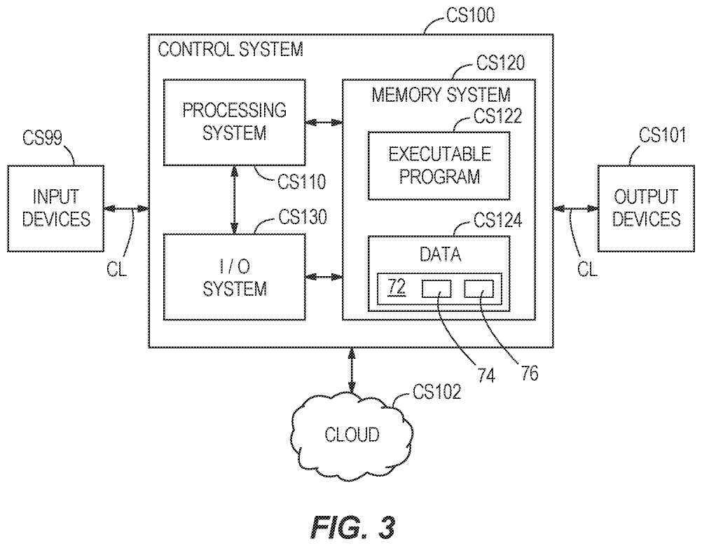

FIG. 3 depicts an exemplary computing system CS100 such as may be used within the local computer 82 (also referred to as an edge based system, for example an Odroid H2+) and/or remote computer 70 (e.g., Microsoft's cloud-based Azure system). Certain aspects are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

In certain examples (as shown in FIG. 3), the control system CS100 communicates with each of the one or more components of the system 30 via a communication link CL, which can be any wired or wireless link. The control module CS100 is capable of receiving information and/or controlling one or more operational characteristics of the system 30 and its various sub-systems by sending and receiving control signals via the communication links CL. The communication link CL lines are meant only to demonstrate that the various control elements are capable of communicating with one another, and do not represent actual wiring connections between the various elements, nor do they represent the only paths of communication between the elements.

The control system CS100 may be a computing system that includes a processing system CS110, memory system CS120, and input/output (I/O) system CS130 for communicating with other devices, such as input devices CS99 (e.g., wireless receiver 68) and output devices CS101 (e.g., a display for the operator of the moving device 40, or a wireless transmitter 66), either of which may also or alternatively be stored in a cloud 102. The processing system CS110 loads and executes an executable program CS122 from the memory system CS120, accesses data CS124 stored within the memory system CS120, and directs the system 30 to operate as described in further detail below.

The processing system CS110 may be implemented as a single microprocessor or other circuitry, or be distributed across multiple processing devices or sub-systems that cooperate to execute the executable program CS122 from the memory system CS120. Non-limiting examples of the processing system include general purpose central processing units, application specific processors, and logic devices.

The memory system CS120 may comprise any storage media readable by the processing system CS110 and capable of storing the executable program CS122 and/or data CS124 (e.g., the database 72 of asset data 74 and asset locations 76 for the assets 20, a map of the property 2 similar to that shown in FIG. 2, and/or the like). The memory system CS120 may be implemented as a single storage device, or be distributed across multiple storage devices or sub-systems that cooperate to store computer readable instructions, data structures, program modules, or other data. The memory system CS120 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

In this manner, the local computer 82 and/or remote computer 70 are configured to execute an algorithm (e.g., stored in the memory system CS120) to determine the asset locations of assets 20 based on the following inputs:
the geographic location XYZ of the moving device 40 at a given time (including whether or not any tags 22 are being read at that given time),
changes to the geographic location XYZ of the moving device 40 over time,
a direction of travel (and in certain examples a compass heading) for the moving device 40 (which may include information from a compass on the moving device 40),
which of the tag readers 50 are reading a given tag 22 at a given time (quadrant determination),
changes to which of the tag readers 50 are reading the given tag 22 over time,
which of the assets 20 is associated with the given tag 22 (and other tags being read)
the signal strength of the given tag 22 read at a given time (and the type of tag, whether passive or active, for example), and
changes to the signal strength of the particular tag 22 read over time, for example.

In other examples, the algorithm includes as inputs: the xyz location of tag reader, the EPC code read from the tag, an antenna number among the individual tag readers, an antenna strength, and timestamp. The range for reading the tag 22 is based on the strength of the antenna, in certain examples with an accuracy of 5 feet or less. The algorithm may further integrate a “quality factor” of the read for a given tag 22 based on other known-good readings. For example, if there is a strong signal reading for a tag 22 associated with a large item of known dimensions, with a relatively weaker reading from another tag 22 associated with a small item, it may be determined that the tag 22 for the small item is behind the large item (e.g., if the large item has remained stationary for a long time).

In certain examples, the algorithm is executed to identify the locations of the tags 22 via the local computer 82 (also referred to as an edge device) aboard the moving device 40, whereas in others it is executed by a remote computer 70 elsewhere (including offsite or via the cloud CS102).

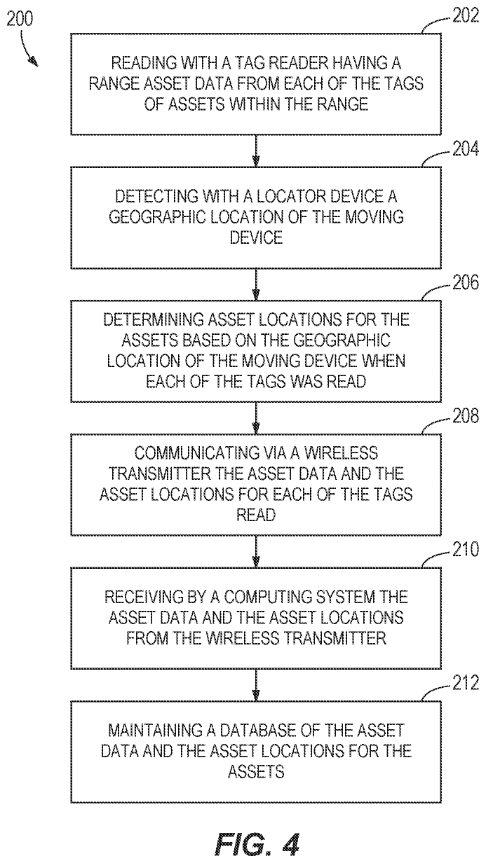

FIG. 4 depicts an exemplary method 200 for tracking assets according to the present disclosure. Step 202 provides for reading with a tag reader having a range assets data from each of the tags of assets within the range. Step 204 provides for detecting with a location tracker a geographic location of the moving device, then step 206 determining asset locations for the assets based on the geographic location of the moving device when each of the tags was red. Step 208 provides for communicating via a wireless transmitter the asset data and the asset locations for each of the tags red, and receiving in step 210 by computing system the asset data and the asset locations from the wireless transmitter. Step 212 provides for maintaining a database of the asset data and the asset locations for the assets, which may be stored locally within the area and/or in a cloud-based system.

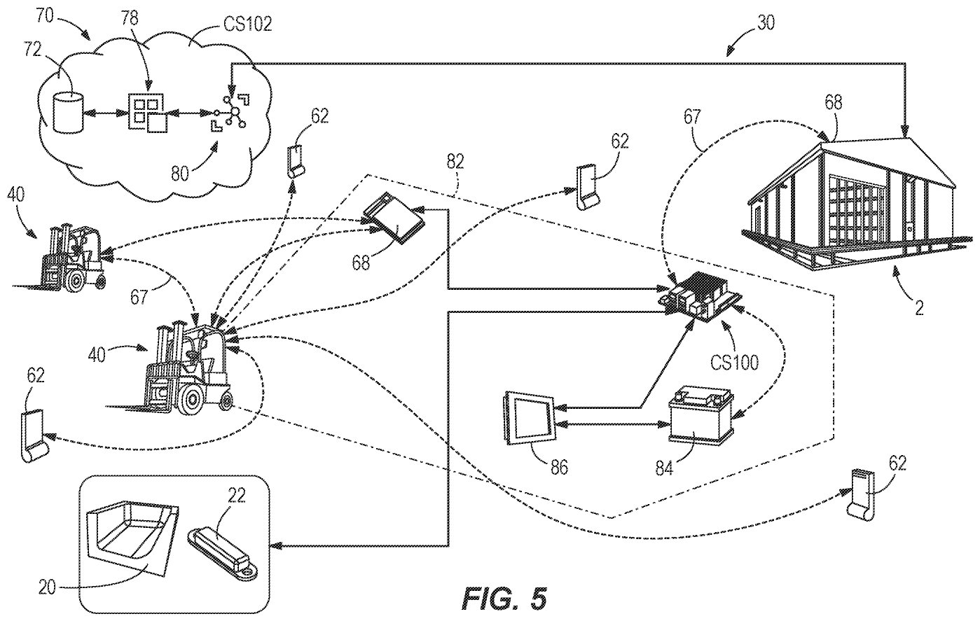

FIG. 5 depicts a representative view of a system 30 with forklifts as the moving devices 40. As previously discussed, the moving device 40 may communicate via a wireless communication path 67 between its wireless transmitter 66 and a wireless receiver 68 in a property 2 that are connected to the remote computer 70. In addition, moving devices 40 may communicate with another moving device 40 that are within range of the wireless receiver 68 to therefore relay information. In the configuration of system 30 shown, the information communicated to the wireless receiver 68 is further communicated to a cloud CS102. This may occur through an internet of things (IoT) hub 80 that communicates with a material management system 78 as well as the database 72 for storing the asset data and asset locations discussed above. Communication between the local computer 82, remote computer 70, and/or cloud CS102 may also be via a wireless access point 88 in a manner known in the art.

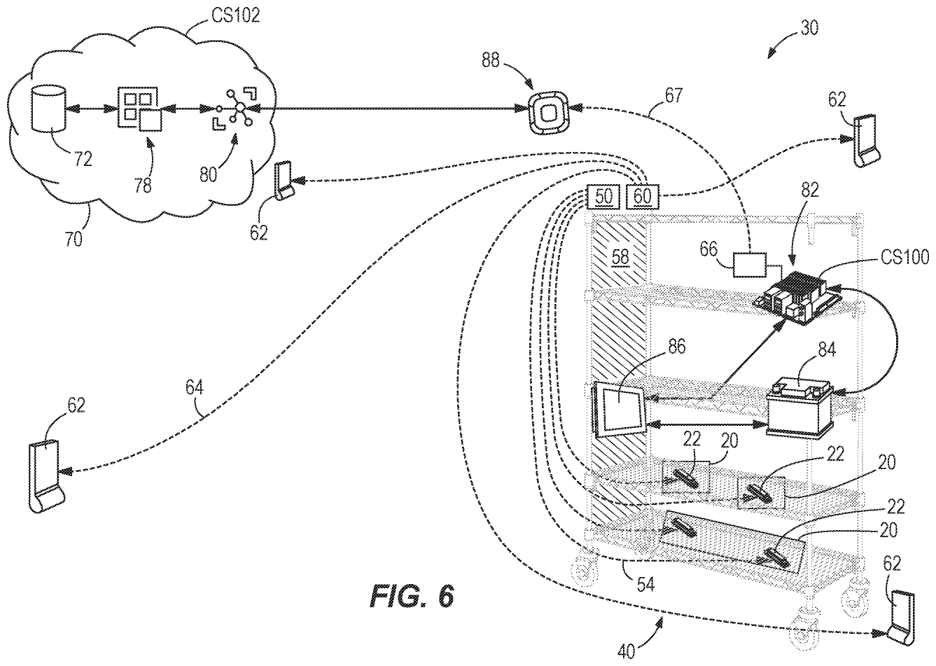

FIG. 6 shows another representation in which a cart is the moving device 40, for example a wire rack rolled manually by a material handler. In this example, individual assets 20 having one or more tags 22 are positioned on the moving device 40, which has a tag reader 50 for reading the tags 22 within proximity thereof. In addition to having a shield for dividing the moving device 40 into quadrants as discussed above (not shown here), this moving device 40 includes one or more shields 58 to distinguish between tags 22 associated with assets 20 on the moving device 40 (e.g., the shields 58 being on the sides of the cart with a tag reader 50 contained therebetween), and those merely within range of a tag reader 50 outside the shield 58 as the moving device 40 is moved about the property 2. This allows for automated tracking of which assets 20 are on the moving device 40, and which are not (while still collecting asset data and asset location information corresponding thereto). In this example, the moving device 40 includes a local computer 82 thereon, which may be a single board computer such as an Odroid H2+, which may communicate via the wireless transmitter 66 to a wireless access point 88 in wireless communication with a cloud CS102.

In certain embodiments, the knowledge of which tag 22 it being transported by the moving device 40 further ties into manufacturing processes, for exampling starting a process or launching a calibration at a workstation for the item associated with that tag 22. In other cases, the storage locations can be optimized based on production needs and historical information to minimize the distance of travel for these assets. Additionally, the knowledge of where a given asset is located, rather than planning for an unknown amount, provides that the timing for moving assets can be more closely tied to the intended time of use. In other words, the presently disclosed system 30 provides for “just in time”, lean delivery of assets, knowing the delivery time with much greater accuracy than methods presently known in the art. Likewise, fewer moving devices 40 (and drivers thereof) are required with the presently disclosed system 30, as the system 30 eliminates the time-consuming need for driving around manually searching for a given asset.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

1. A system for tracking an asset having a tag using a moving device, the system comprising:
a first tag reader and a second tag reader each having a range, each being located on the moving device, and each being configured to read asset data from the tag when the tag is within the range thereof;
a physical shield configured to block the first tag reader and the second tag reader from reading the tag therethrough, wherein the physical shield defines regions around the moving device such that the first tag reader and the second tag reader each read the tag within one of the regions, respectively;
a location tracker that detects a geographic location of the moving device, wherein an asset location is determined for the asset based on which of the first tag reader and the second tag reader read the asset data from the tag and based on the geographic location of the moving device;
a wireless transmitter located on the moving device, wherein the wireless transmitter communicates the asset data and the asset location determined for the asset; and
a computing system that receives the asset data and the asset location for storage thereof.

2. The system according to claim 1, wherein the location tracker includes three or more fixed anchors for detecting the geographic location of the moving device relative thereto.

3. The system according to claim 1, further comprising a memory system located on the moving device, wherein the memory system stores the asset data and the asset location for the tag until received by the computing system.

4. The system according to claim 1, further comprising recording a time when the tag is read, wherein the asset location is determined based at least in part of the time.

5. The system according to claim 21, wherein at least one of the plurality of assets has at least two tags within the plurality of tags associated therewith.

6. (canceled)

7. The system according to claim 1, wherein the first tag reader and the second tag reader are positioned to read the tag in differing directions from each other relative to the moving device.

8. A system for tracking assets having tags using a moving device, the system comprising:
a first tag reader and a second tag reader each being located on the moving device, each having a range, and each being configured to read asset data from each of the tags within the range thereof;
a physical shield configured to block the first tag reader and the second tag reader from reading the tags therethrough, wherein the physical shield defines regions around the moving device such that the first tag reader and the second tag reader each read the tags within one of the regions, respectively;
a location tracker that determines a geographic location of the moving device, wherein asset locations are determined for the assets based on the geographic location of the moving device;
a wireless transmitter located on the moving device, wherein the wireless transmitter communicates the asset data and the asset locations for each of the tags that have been read; and
a computing system that receives the asset data and the asset locations for storage thereof.

9. The system according to claim 1, wherein the first tag reader and the second tag reader are further configured to determine a signal strength from the tag, and wherein the asset location for the asset is also based on the signal strength from the tag when read.

10. The system according to claim 1, wherein the location tracker determines the geographic location of the moving device in three dimensions, and wherein the asset location is correspondingly determined and stored corresponding to the three dimensions.

11. A system for tracking assets having tags using a first moving device and a second moving device, the system comprising:
a first tag reader and a second tag reader each having a range, each being located on the first moving device, and wherein the being configured to read asset data from each of the tags within the range thereof;
a physical shield configured to block the first tag reader and the second tag reader from reading the tags therethrough, wherein the physical shield defines regions around the moving device such that the first tag reader and the second tag reader each read the tags within one of the regions, respectively;
a location tracker that detects a geographic location of the first moving device, wherein asset locations are determined for the assets based on the geographic location;
a wireless transmitter located on the first moving device and configured to communicate the asset data and the asset locations for each of the tags read to the second moving device for communication to a computing system that receives the asset data and the asset locations for storage thereof.

12. The system according to claim 1, wherein the tag is an RFID tag and the first tag reader and the second tag reader are RFID tag readers, wherein the location tracker determines the geographic location of the moving device in three dimensions, wherein the wireless transmitter communicates using Wi-Fi, and wherein the moving device is a forklift.

13. A method for tracking an asset having a tag using a moving device, the method comprising:
reading with a first tag reader and a second tag reader each having a range asset data from the tag when the tag is within the range corresponding thereto, wherein the first tag reader and the second tag reader are located on the moving device, and wherein a physical shield blocks the first tag reader and the second tag reader from reading the tag therethrough so as to define regions around the moving device wherein the first tag reader and the second tag reader are configured to each read the tag within one of the regions, respectively;
detecting with a location tracker a geographic location of the moving device, wherein the location tracker is located on the moving device, and wherein an asset location is determined for the asset based on which of the first tag reader and the second tag reader read the asset data from the tag and based on the geographic location of the moving device;
communicating via a wireless transmitter the asset data and the asset location determined for the asset, wherein the wireless transmitter is located on the moving device; and
receiving via a computing system the asset data and the asset location for storage thereof.

14. The method according to claim 13, further comprising storing in a memory system located on the moving device the asset data and the asset location determined for the asset until received by the computing system.

15. (canceled)

16. The method according to claim 13, further comprising reading the tag multiple times and determining the geographic location for the moving device as multiple geographic locations each corresponding to one of the multiple times that the tag is read, and further comprising determining the asset location of the asset based on the multiple geographic locations determined for the moving device.

17. The method according to claim 13, further comprising positioning the first tag reader and the second tag reader to read the tag in differing directions from each other relative to the moving device.

18. The method according to claim 13, further comprising reading a signal strength from the tag, and further comprising determining the asset location for the asset based on the signal strength from the tag.

19. The method according to claim 13, wherein the moving device is a first moving device, further comprising communicating via the wireless transmitter the asset data and the asset location determined for the asset to a second moving device for communication to the computing system.

20. A system for tracking assets having RFID tags using a moving device, the system comprising:
four RFID tag readers each having a range and each located on the moving device;
a physical shield that divides the moving device into four quadrants, wherein each of the four RFID tag readers is located within a separate one of the four quadrants and the physical shield is configured to block the four RFID tag readers from reading therethrough such that each of the four RFID tag readers is configured to read asset data from each of the RFID tags within the range thereof;
a location tracker located on the moving device, wherein the location tracker detects a geographic location of the moving device, and wherein the asset locations are determined for the assets based on the geographic location of the moving device when each of the RFID tags was read;
a wireless transmitter located on the moving device, wherein the wireless transmitter communicates the asset data and the asset locations for each of the tags read by any of the four tag readers;
a computing system that receives the asset data and the asset locations for storage thereof; and
a memory system that stores the asset data and the asset locations for each of the RFID tags read until received by the computing system.

21. The system according to claim 1, wherein the asset is one of a plurality of assets and the tag is one of a plurality of tags corresponding to the plurality of assets, and wherein the first tag reader and the second tag reader are each configured to read asset data from each asset within the plurality of assets that is within the range thereof.

22. The system according to claim 8, where the asset locations are also determined based on which of the first tag reader and the second tag reader read each the tags and the one of the regions around the moving device corresponding thereto.

23. (canceled)
